(19) United States
(12) Patent Application Publication
(10) Pub. No.: US 2016/0004250 A1
(43) Pub. Date: Jan. 7, 2016

(54) Ultra High Speed Navigation Magnetic Satellite and Unmanned Aircraft

(71) Applicant: James Pan, Hanover, MD (US)

(72) Inventor: James Pan, Hanover, MD (US)

(21) Appl. No.: 14/322,957

(22) Filed: Jul. 3, 2014

(51) Int. Cl. G05D 1/00; B64C 39/02; B64C 17/00; B64G 1/10

(52) U.S. Cl. CPC G05D 1/00; B64G 1/10; B64C 39/024; B64C 17/00; B64C 2201/04

(57) ABSTRACT

The present invention is about a new satellite or unmanned aircraft guided by earth's magnetic fields, instead of gravitational fields, as in the case of traditional satellites. This type of magnetic satellites can fly many times faster than traditional satellites, and sustain a much heavier load if necessary. In order to navigate in earth's magnetic fields, the magnetic satellite needs to be heavily charged. The charges, interacting with the magnetic field, induce a magnetic force, which replaces the gravitational force as the centripetal force for circular motion.

### FIELD OF THE INVENTION

The present invention relates generally to satellites or unmanned aircrafts, and more particularly, to magnetic satellites or unmanned aircrafts.

### BACKGROUND OF THE INVENTION

The present invention describes a magnetic satellite or unmanned aircraft, which carriers electric charges and cruises according to earth's magnetic fields. Traditional satellites only follow earth's gravitational fields, and do not respond to earth's magnetic fields.

### SUMMARY OF THE INVENTION

The following presents a simplified summary in order to provide a basic understanding of one or more aspects of the invention. This summary is not an extensive overview of the invention, and is neither intended to identify key or critical elements of the invention, nor to delineate the scope thereof Rather, the primary purpose of the summary is to present some concepts of the invention in a simplified form as a prelude to the more detailed description that is presented later.

The present invention provides a magnetic satellite or unmanned aircraft which carriers electric charges to react with earth's magnetic fields and generate a centripetal force. The motion of the satellite follows this electromagnetic field generated centripetal force, instead of the gravitational force which guides a traditional satellite. S the result of this magnetic force, this new satellite may fly man times faster than a traditional gravitational satellite. The speed of the magnetic satellite can be adjusted by the electric charges. The speed of a traditional gravitational satellite is much lower, can not be adjusted, and is determined only by the altitude of the satellite.

To the accomplishment of the foregoing and related ends, the invention comprises the features hereinafter fully described and particularly pointed out in the claims. The following description and the annexed drawings set forth in detail certain illustrative aspects and implementations of the invention. These are indicative, however, of but a few of the various ways in which the principles of the invention may be employed. Other objects, advantages and novel features of the invention will become apparent from the following detailed description of the invention when considered in conjunction with the drawings.

### BRIEF DESCRIPTION OF THE DRAWINGS

FIG. 1 describes magnetic satellite or unmanned aircraft with multiple wings connecting the main body of the satellite to the electric charge carrying devices. The electric charges from these devices react with earth's magnetic fields to support the centripetal force necessary for guiding the motion of the satellite.

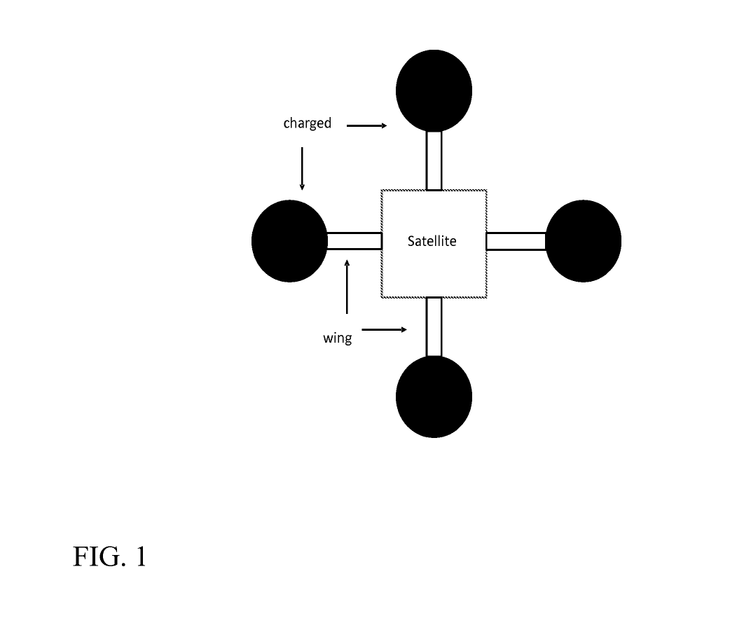

FIG. 2 describes magnetic satellite where the main body is supported by an array of electric charge carrying devices. These electric charge carrying devices may form a linear array, or two dimensional array, or multiple dimensional arrays.

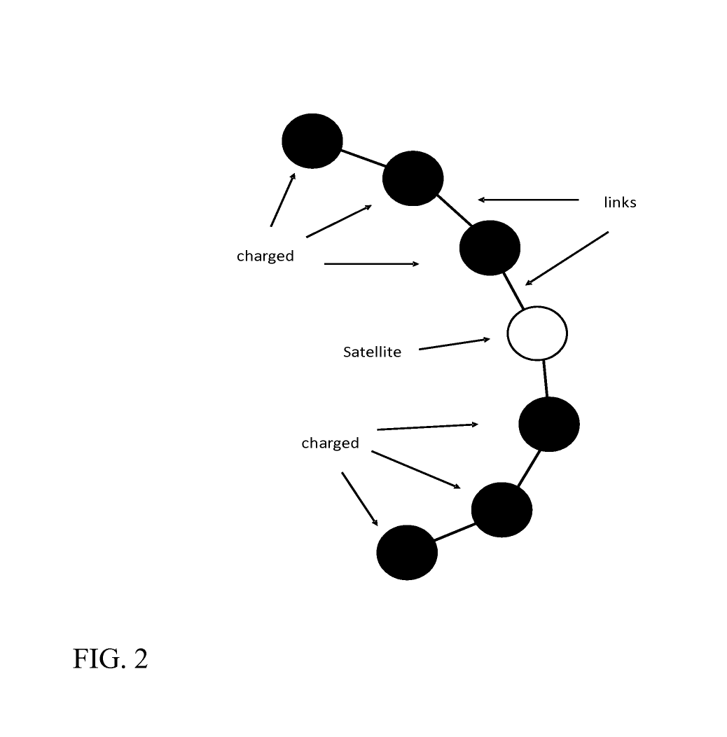

FIG. 3 shows an electric charge carrying device, including a metal ball where the electric charges are stored, and a layer of insulator surrounding the metal ball. There is a computer programmed outside layer which can shield some of the charges with metal doors.

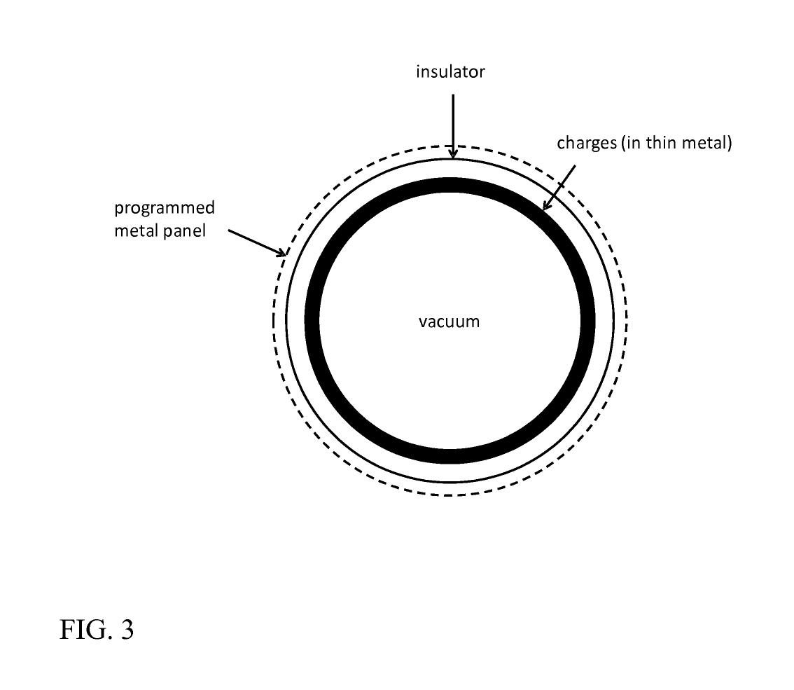

FIG. 4 illustrates how the outer panel is designed: the panel consists of metal units (black color squares)—computer program is used to control which unit is black (blocked by metal) and which unit should remain white (door open).

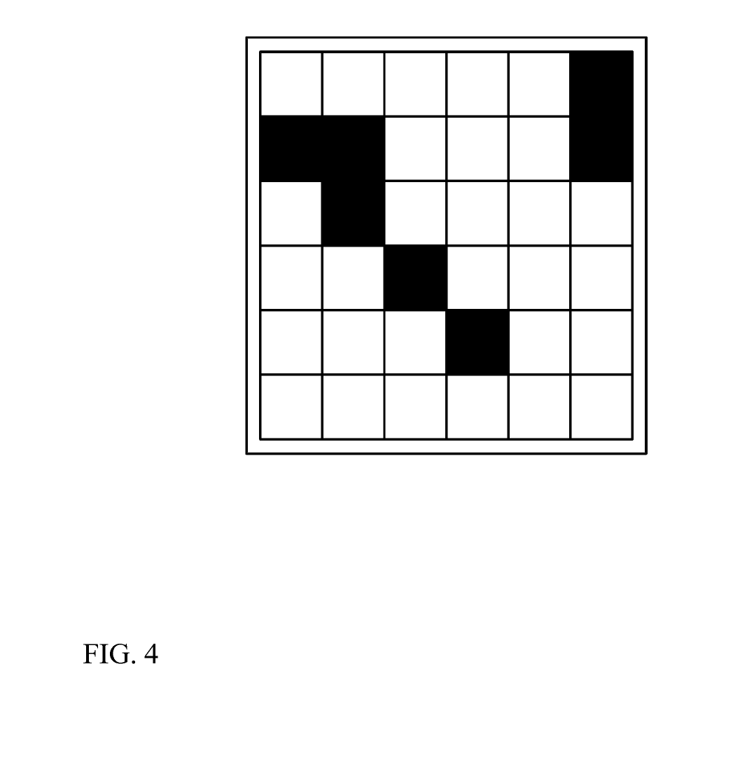

FIG. 5 describes how each unit in FIG. 6 is designed—a metal door screens the charges inside and block the electric field to interact with earth's magnetic fields, modulating the magnetic force guiding the speed and altitude of the magnetic satellite.

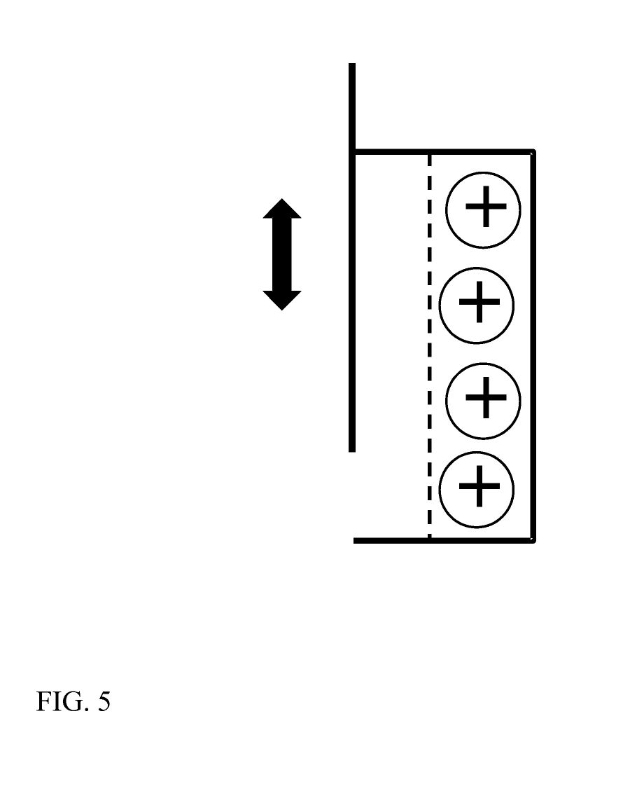

FIG. 6 shows another way to construct a charged device—similar to a semiconductor nonvolatile memory, where a conductor is sandwiched by insulators and charges can be injected into this conductor by the floating gate (conductor outside) and control gate (sandwiched conductor). In the center is a semiconductor region.

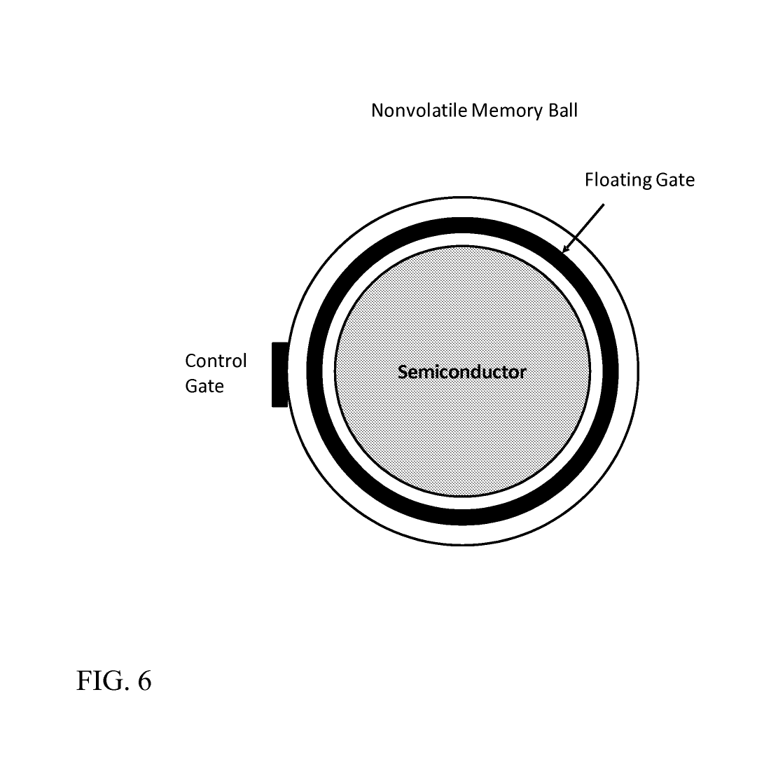

FIG. 7 shows the directions of the magnetic force, earth's magnetic field, and the direction of the velocity of the satellite—these 3 directions are in perpendicular to one another. Magnetic Force=(Amount of Electric Charges) times ((Velocity of The Satellite)×(Earth's Magnetic Field)).

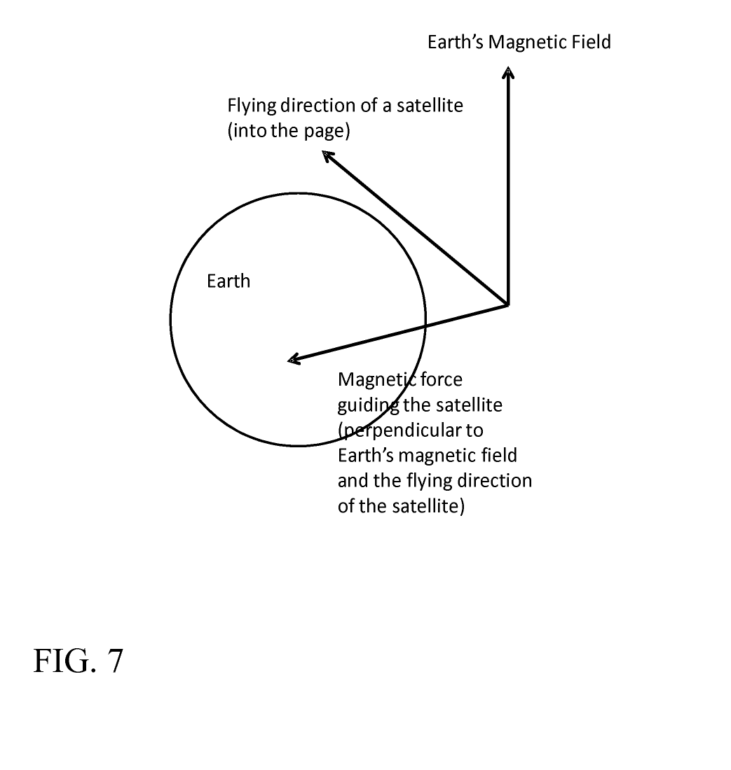

### DETAILED DESCRIPTION OF THE INVENTION

The present invention will now be described with respect to the accompanying drawings in which like numbered elements represent like parts. The figures provided herewith and the accompanying description of the figures are merely provided for illustrative purposes. One of ordinary skill in the art should realize, based on the instant description, other implementations and methods for fabricating the devices and structures illustrated in the figures and in the following description.

When electric charges move in a magnetic field, according the electromagnetic theories, a magnetic force is generated. The direction of the magnetic force is perpendicular to both the magnetic field and the moving direction of the electric charges. The magnitude of the magnetic force is proportional to the speed of the moving charges and the magnetic field strength, as well as the amount of electric charges.

A satellite which carries electric charges can fly according to the magnetic force generated by the reaction of the electric field from the electric charges and earth's magnetic fields. By following this magnetic force, a magnetic satellite can fly many times faster than a traditional gravitational satellite, up to the speed of light. A traditional gravitational satellite moves much slower, and can not change the speed without changing the altitude. The speed of a magnetic satellite can be adjusted by changing the electric charges carried by the satellite.

The control center, or the main body of the satellite, is sustained by an array of electric charge carrying devices. These charge carrying devices react with earth's magnetic fields and supply the centripetal forces necessary to guide the magnetic satellite.

Electric charges can leak if they are in contact with air, water, moisture, or other substances. In order to prevent the charges from leaking, a layer of insulator surrounds the electric charges, which are typically stored in metal surfaces.

The electric field from the electric charges can not go through metals. By adjusting the electric fields, the magnetic force can be adjusted. In order to adjust the amount of electric charges, an outside layer is programmed to provide different sizes of metal surfaces, as these metal surfaces can block the electric fields from the charges.

Although the invention has been shown and described with respect to a certain aspect or various aspects, it is obvious that equivalent alterations and modifications will occur to others skilled in the art upon the reading and understanding of this specification and the annexed drawings. In particular regard to the various functions performed by the above described components (assemblies, devices, circuits, etc.), the terms (including a reference to a “means”) used to describe such components are intended to correspond, unless otherwise indicated, to any component which performs the specified function of the described component (i.e., that is functionally equivalent), even though not structurally equivalent to the disclosed structure which performs the function in the herein illustrated exemplary embodiments of the invention. In addition, while a particular feature of the invention may have been disclosed with respect to only one of several aspects of the invention, such feature may be combined with one or more other features of the other aspects as may be desired and advantageous for any given or particular application. Furthermore, to the extent that the term “includes” is used in either the detailed description or the claims, such term is intended to be inclusive in a manner similar to the term “comprising.”

1. A magnetic satellite or unmanned aircraft consists of one or multiple dimensions of arrays of heavily charged regions, each of which is sandwiched by insulators or in vacuum, with wings and links connecting to other charged regions or a central commanding unit or main body of the satellite or unmanned aircraft.

2. The magnetic satellite or unmanned aircraft of claim 1, wherein the charged regions can be shielded by computer programmed or controlled metal panels or units, in order to regular the amount of electric fields originating from the charges.

3. The magnetic satellite or unmanned aircraft of claim 1, wherein the magnetic, gravitational, and wind forces are sensed and regulated to guide the motions of the satellite or unmanned aircraft equipped with jet or missile engines.

4. The magnetic satellite or unmanned aircraft of claim 1, wherein the charged region or device is a spherical or other shaped conductor shell, surrounded and sandwiched by insulators, with a semiconductor region in the center core, and a metal in contact with the outside insulator in order to regular the voltage for injecting electric charges into the conductor.
